(19) United States
(12) Patent Application Publication
(10) Pub. No.: US 2026/0213584 A1
(43) Pub. Date: Jul. 23, 2026

(54) WIRELESS POWER TRANSFER SYSTEM AND METHODS

(71) Applicant: Imperial College Innovations Limited, London (GB)

(72) Inventors: Paul D. MITCHESON, London (GB); Christos PAPAVASSILIOU, London (GB); James GAWITH, London (GB); Nunzio PUCCI, London (GB)

(21) Appl. No.: 19/461,499

(22) Filed: Jan. 27, 2026

Related U.S. Application Data
(63) Continuation of application No. PCT/EP2024/071386, filed on Jul. 26, 2024.

(30) Foreign Application Priority Data
Jul. 28, 2023 (GB) 2311633.8

(51) Int. Cl. H02J 50/80; H02J 50/12; H02J 50/90

(52) U.S. Cl. CPC H02J 50/80; H02J 50/12; H02J 50/90

(57) ABSTRACT

A wireless power transfer system comprising: a transmitter unit, the transmitter unit comprising a first transceiver coupled to a first inductive coil and configured to drive the first inductive coil; and a receiver unit, the receiver unit comprising a second transceiver coupled to a second inductive coil for inductive coupling with the first inductive coil; wherein the receiver unit further comprises an injection-locked oscillator coupled to the second transceiver for defining an oscillation frequency of the second transceiver, the injection-locked oscillator configured to synchronize with a driving frequency of the transmitter unit.

### RELATED APPLICATIONS

This application is a continuation of PCT Patent Application PCT/EP2024/071386, filed Jul. 26, 2024, which claim priority to Great Britain Patent Application No. 2311633.8, filed Jul. 28, 2023, the disclosures of which are incorporated herein by reference.

### SUMMARY OF THE INVENTION

This work was supported by the UK Engineering and Physical Sciences Council and the ERPSRC grant number EP/N509486/1, EP/R513052/1 and EP/R029504/1.

### FIELD

The present disclosure relates to a wireless power transfer system, and to corresponding methods.

### BACKGROUND

Wireless Power Transfer (WPT), for example inductive power transfer (IPT), is becoming commonplace for powering and charging of electrical devices. Currently, wireless power transfer is most commonly used for comparatively low-power applications. However, there is an interest in implementing inductive WPT in higher power inductive power transfer (HP-IPT).

Active-passive systems are often used for IPT. In an active-passive system, the receiver is a passive component, and is only able to operate as a receiver. Active-passive systems are therefore only suitable for unidirectional power transfer. Another drawback with active-passive systems is that reflected reactance in the system can cause detuning of the system, making such systems difficult to tune for varying operating conditions (such as varying separation distance, varying coil overlap, varying temperature). Losses due to detuning become more difficult to manage for higher power systems.

Active-active systems are gaining interest for use in IPT. In an active-active system, both the transmitter and the receiver are active components, and may be reconfigurable for bidirectional power transfer. Active-active systems may address the tuneability issues faced with active-passive systems and can be more efficient than active-passive systems. However, active-active systems are hard to implement. In particular, obtaining a stable frequency and phase reference between the transmitter and the receiver is challenging in an active-active system, which in turn causes poor synchronization, and thus poor power efficiency relative to many active-passive systems. In some systems, a separate communication link may be used to facilitate synchronization. However, such a separate communication link increases the complexity and cost of the system and can be difficult to scale to high-frequency operation, such as MHz operation.

### SUMMARY

The present invention has been developed to address problems noted above.

In a first aspect there is provided a wireless power transfer system comprising: a transmitter unit (first unit), the transmitter unit comprising a first transceiver coupled to a first inductive coil and configured to drive the first inductive coil; and a receiver unit (second unit), the receiver unit comprising a second transceiver coupled to a second inductive coil for inductive coupling with the first inductive coil; wherein the receiver unit further comprises an injection-locked oscillator coupled to the second transceiver for defining an oscillation frequency of the second transceiver, the injection-locked oscillator configured to synchronize with a driving frequency of the transmitter unit (e.g., synchronize with the frequency at which the first coil is driven). For example, the injection-locked oscillator may be provided to synchronize an oscillation frequency of the second transceiver with the driving frequency of the transmitter unit.

An injection-locked oscillator may alternatively be referred to as an injection-lock oscillator, e.g. an oscillator which is configured to injection lock with another frequency. Injection-locked oscillator is a term of the art in the field of RF communication systems.

Herein, a transmitter unit is defined as a unit of a wireless power transfer system which is configured to inductively transmit energy. Equivalently, a receiver unit is defined as a complementary unit of a wireless power transfer system which is configured to inductively couple with such a transmitter in order to receive and capture the inductively transmitted energy.

As the reader will understand, because the transmitter unit of the first aspect comprises a transceiver, it may be alternatively configurable as a receiver (e.g., by switching the first transceiver from a transmission mode to a receive mode). Similarly, because the receiver unit of the first aspect comprises a second transceiver, it may be alternatively configurable as a transmitter (e.g., by switching the second transceiver to a transmit mode). That is to say, the transmitter unit of the first aspect may be a transmit/receive unit in which the first transceiver is switched to operate as a transmitter; and the receiver unit of the first aspect may be a transmit/receive unit in which the second transceiver is switched to operate as a receiver.

By using a transceiver-based receiver, bidirectional power transfer may be possible (e.g., by switching the transmitter to operate as a receiver; and by switching the receiver to operate as a transmitter). By contrast, if a passive receiver were to be used (e.g., a receiver which does not comprise a transceiver), this would not be possible. Because both the transmitter unit and the receiver unit in the present disclosure are transceiver-based, the system forms an active-active system (as opposed to an active-passive system). More generally, an active component can, by definition, be used as a transceiver (i.e. as a transmitter or a receiver).

Without being bound by theory, it has been found by the inventors that the provision of an active-active system, as opposed to an active-passive system, improves tuneability. Again, without wishing to be bound by theory, it is thought that this is because transceivers are transistor-based, rather than diode based. In an active-passive system, the load that the receiver reflects to the transmitter is determined by the coupling factor, the rectifier circuit topology and the load, and cannot be independently controlled for a given operating condition of the system, and may contain a reactive component. However, given that active-active systems contain a circuits on each side of the link that are controlled with transistors, modifying the relative phase of driving signals of the transistors controls the reflected load, allowing tuning to be achieved independently of system operating condition by minimising the reflected reactance.

Herein, injection-locking is defined as a process by which one side of the system locks onto the frequency of the other side of system, such that the two sides of the system become synchronized with one another. Where a first component injection locks onto a second component, it is to be understood that the first component adopts the frequency of the second component. The inventors have found that an injection-locked oscillator can be used in the active-active system of the present disclosure in order to obtaining a stable frequency and phase reference at the receiver (in particular by locking onto the driving frequency on the transmitter-side). Accordingly, synchronization is improved relative to active-active systems of the prior art, particularly for MHz operation.

By providing the injection-locked oscillator coupled to the second transceiver, the driving frequency of the transmitter unit will set the oscillation frequency of the system, and the receiver unit will lock onto that driving frequency. This is advantageous for ensuring that the driving frequency of the transmitter unit does not deviate from its defined ISM band. Typically, the transmitter will be configured to operate in the 13.56 MHz band or the 6.78 MHz band. However, as the skilled person will understand, the present disclosure is not limited to these frequency bands, and other frequency bands could be used.

By allowing the receiver unit to synchronize with the transmitter unit, efficiency of power transfer between the transmitter and the receiver may be improved. Additionally, tolerance of the system to increased separation distance between the first and second coils, and/or to reduced overlap between the first and second coils, may be improved. Efficiency and robustness of the system may therefore be improved.

By using an injection-locked oscillator on the receiver to achieve synchronization between the first and second transceivers, no separate communication link is needed to achieve synchronization between the transmitter and receiver units. Frequency synchronization is ensured, and by extension the relative phase of the current in the transceiver coils remains fixed at 90°, such that power transfer is maximised and reflected reactance is minimised or eliminated. Operation under very low coupling conditions (for example large coil separation, or poor coil overlap) may therefore be achievable. System robustness may therefore be improved.

Notably, if the receiver unit is to be used with multiple different transmission units at different times, each of which may have a slightly different driving frequency, injection locking is needed to maximise efficiency when coupling with each transmission unit. Similarly, crystal oscillators have oscillation frequencies which are temperature dependent. Accordingly, in order to maximise efficiency subject to temperature fluctuations, injection locking is similarly needed.

The transmitter unit may further comprise an oscillator coupled to the first transceiver, the oscillator defining a stable oscillation frequency of the first transceiver. The oscillator of the transmitter unit may be a crystal oscillator having a fixed oscillation frequency. In some examples, the transmitter unit may (also) comprise an injection-locked oscillator. The ILO coupled to the second transceiver, and the oscillator coupled to the first transceiver, may be selected to have similar natural oscillation frequencies to one another, for example sufficiently similar for effective injection locking to be achieved. For example, they may be selected such that the natural oscillation frequency of the ILO is no more than 10% different from the oscillation frequency of the oscillator coupled to the first transceiver (e.g. no less than 90% of the oscillation frequency of the oscillator and no more than 110% of the oscillation frequency of the oscillator). For example, the natural oscillation frequency of the ILO may be no more than 5% different from the oscillation frequency of the oscillator, such as no more than 2% different from the oscillation frequency of the oscillator. In an exemplary embodiment, the natural oscillation frequency of the ILO may be about 1% different from the oscillation frequency of the oscillator.

The injection-locked oscillator may be a voltage controlled injection-locked oscillator having a voltage-tuneable natural oscillating frequency. Accordingly, it may be possible to tune the injection locked oscillator so that it approximately matches the driving frequency of the transmission unit, thereby enhancing injection locking.

Where the transmitter comprises a crystal oscillator, the injection-locked oscillator of the receiver may be configured to synchronize with the oscillation frequency of the crystal oscillator.

The injection-locked oscillator may have a low Q-factor, for example a Q-factor of less than 200, such as a Q factor of less than 100. The Q factor may in some examples be below 90, for example between 80 and 90. The injection-locked oscillator may be a non-linear oscillator.

At least one of the first transceiver and the second transceiver may be a class EF transceiver. The inventors have found that class EF transceivers are well-suited to applications in which coupling factor is variable, for example due to varying coil separation or varying coil overlap. The transceivers may be load independent class EF transceivers. Such class EF transceivers have been found in many cases to further improve system robustness.

The first transceiver and the second transceiver may be of the same class. In some examples, they may be substantially identical. The second transceiver may be tuned to achieve load independence from the first transceiver. In some examples, both transceivers may be tuned to achieve load independence from one another. They may accordingly be defined herein as load-independent transceivers.

At least one of the first coil and the second coil may be an air-core coil. That is, at least one of the first coil and the second coil may be free of a ferromagnetic core. This may help to achieve unconstrained magnetic flux, and hence improve efficiency of power transfer over a wide range of relative coil positions.

The system may be a high-power system. For example, the system may be configured to operate at powers of at least 2 kW, for example at least 4 kW, and in some examples at least 10 kW, for example at least 15 kW.

The receiver unit may further comprise a delay line configured to maintain a phase offset of 90° relative to the transmitter unit. Accordingly, the delay line may help to ensure maximum power transfer.

One problem with injection-locked oscillators is that they are susceptible to temperature change. In particular, the natural oscillating frequency of an injection-locked oscillator will change in response to changing temperature. In order to ensure effective injection locking in the system according to the present disclosure, it may be necessary to ensure that the difference in frequency between the injection locked oscillator and an oscillator on the transmission unit does not exceed a predetermined limit (if the difference exceeds the predetermined limit, injection locking may not occur). To account for this, adjustment of the natural oscillating frequency of the injection-locked oscillator with temperature may be required.

Accordingly, the injection-locked oscillator may be a voltage-controlled injection-locked oscillator having a voltage-tuneable natural oscillating frequency. The natural oscillating frequency may be tuneable by varying a voltage applied to the oscillator.

The receiver unit may further comprise a temperature sensor, and a control unit configured to determine a temperature at the receiver unit based on an output from the temperature sensor.

The control unit may be configured to:
determine, based on the output from the temperature sensor, a change in temperature at the receiver unit;
determine, based on a lookup table, a change in natural oscillating frequency of the injection-locked oscillator corresponding to the temperature change;
determine, based on the determined change in natural oscillating frequency, a change in voltage required to counteract the change; and
apply the change in voltage to the injection-locked oscillator.

Accordingly, the receiver unit is able to maintain a consistent natural oscillating frequency even as ambient temperatures change.

Over time, temperature changes may cause an injection of a phase shift between the transmitter unit and the receiver unit. Other ambient conditions, for example electromagnetic interference, may similarly introduce a phase shift. Accordingly, the delay line may be used to account for such phase-shifts between the receiver unit and the transmitter unit. In particular, the control unit may be configured to:
cause the delay line to introduce relative phase perturbations onto an oscillation signal sent to the second transceiver from the injection-locked oscillator;
for each phase perturbation, determine, based on an output from the second transceiver, a power output or induced power at the receiver unit;
determine, based on the power outputs and corresponding phase perturbations, a relative phase perturbation at which the power output or induced power is largest;
control the delay line to maintain the relative phase perturbation at which the power output or induced power is largest.

Accordingly, the system is capable of sweeping through phase changes either side of the current phase change, and then selecting the phase change at which power output or induced power is largest. Accordingly, the system is able to maintain a 90° phase relationship in the coil currents for maximum power output or induced power.

In a second aspect there is provided a method of controlling a receiver unit for use in an inductive power transfer system, the receiver unit comprising a transceiver coupled to an inductive coil, a voltage-controlled injection-locked oscillator coupled to the transceiver for defining an oscillation frequency of the second transceiver, the method comprising:
determining a change in temperature at the receiver unit;
determining a change in natural oscillating frequency of the injection-locked oscillator corresponding to the temperature change;
determining a change in voltage required to counteract the change; and
applying the change in voltage to the injection-locked oscillator.

In a third aspect there is provided a method of controlling a receiver unit for use in an inductive power transfer system, the receiver unit comprising a transceiver coupled to an inductive coil, a voltage-controlled injection-locked oscillator coupled to the transceiver for defining an oscillation frequency of the transceiver, and a delay line, the method comprising:
causing the delay line to introduce relative phase perturbations onto an oscillation signal sent to the transceiver from the injection-locked oscillator;
for each phase perturbation, determining, based on an output from the transceiver, an induced power at the receiver unit;
determining, based on the power outputs and corresponding phase perturbations, a relative phase perturbation at which the induced power is largest; and
controlling the delay line to maintain the relative phase perturbation at which the power output or induced power is largest.

Also disclosed herein is a computer-readable medium (for example a non-transitory computer-readable medium) having instructions stored thereon which, when executed by a processor, cause the processor to perform steps according to the second aspect or the third aspect.

Also disclosed herein is a system comprising a computer readable medium (for example a non-transitory computer-readable medium) and a processor, the computer-readable medium having instructions stored thereon which, when executed by a processor, cause the processor to perform steps according to the second aspect or the third aspect.

Provided later in the Appendix is further information relating to the presently disclosed systems, and their principle of operation. The information in the Appendix is therefore incorporated as part of the present disclosure.

### BRIEF DESCRIPTION OF THE FIGURES

Specific embodiments are now described, by way of example only, with reference to the drawings, in which:

FIG. 1 is a block diagram of a wireless power transfer system according to the present disclosure;

FIG. 2 is a conceptual circuit diagram illustrating the principle of injection locking as used in the system of FIG. 1;

FIG. 3A is a circuit diagram of an example first transceiver and an associated first coil from the system of FIG. 1;

FIG. 3B is a circuit diagram of an example second transceiver and associated second coil from the system of FIG. 1;

FIG. 4 is a circuit diagram of an injection-locked oscillator from the system of FIG. 1;

FIG. 5 illustrates a further inductive power transfer system according to the present disclosure;

FIG. 6 is a flow chart showing a method formed at a transmitter unit from FIG. 1 or 5;

FIG. 7 is a flow chart showing a method formed at a receiver unit from FIG. 1 or 5; and

FIG. 8 is a block diagram showing an example structure of a control unit for use in the system of FIG. 1.

FIG. 9. Circuit diagram of two bidirectional Class EF transceivers with the loads modelled as dependent voltage sources.

FIG. 10. Injection locked oscillator conceptual diagrams.

FIG. 11. Circuit diagrams of the oscillator.

FIG. 12. The experimental setup.

FIG. 13. Coils currents when starting up the system: master in blue, slave (operated by the injection locked oscillator) in orange. The three figures show details at different time points.

FIG. 14. Scope capture of the system operating under injection locking. Coils currents on the top, drain voltage waveforms on the bottom.

FIG. 15. Thermal camera pictures of the system with focus on the injection locked oscillator module.

FIG. 16. Distribution of losses with a coupling factor of 4.5%.

FIG. 17. Block diagram of the system feedback loop.

FIG. 18. Temperature dependence of coils currents relative phases over time.

FIG. 19. Phase between coil currents as a function of raw temperature reading from PT100 and raw input of the ADC to output Vᵢₙ.

FIG. 20. Scope capture of the system operating under injection locking with feedback loop. Coils currents on the bottom, drain voltage waveforms on the top.

FIG. 21. Phase between coil currents and power at the receive side for each iteration of the maximum power point (MPP) tracking algorithm using an exhaustive search between phases of −30° and 180°.

FIG. 22. Revised MPP tracking algorithm based on gradient change.

### DETAILED DESCRIPTION

The present disclosure combines an active-active inductive power transfer (IPT) system, with an injection-locked oscillator (ILO) located at the active receiver, in order to achieve the advantageous features of an active-active system, with the additional advantage of enabling effective frequency and phase tracking at the receiver through the provision of the ILO.

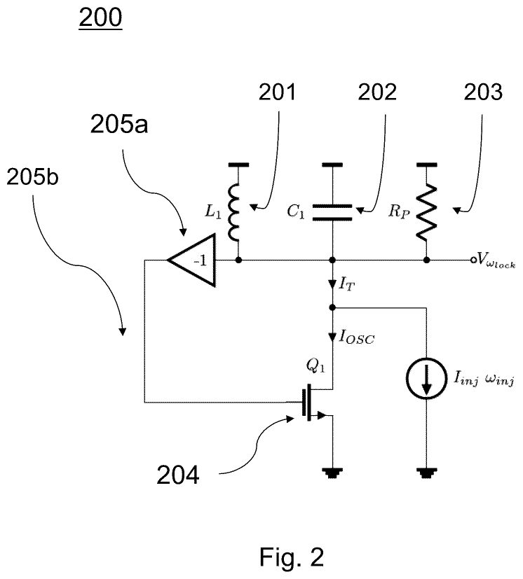

Accordingly, the present disclosure comprises two transceivers, each coupled to a respective coil. When the two coils inductively couple to one another, inductive power transfer between the transceivers is possible. The transceiver configured to be the receiver is coupled to an ILO. The ILO sets the oscillating frequency of the transceiver configured to be the receiver. Further, the ILO synchronises to the frequency of the receiving transceiver to that of the transmitting transceiver, such that the two transceivers become synchronized. The process of synchronization is called injection locking, and will be described in more detail below with reference to FIG. 2. The ability to injection lock the frequency of the receiving transceiver to that of the transmitting transceiver, increases efficiency of power transfer, and may also improve robustness to coil separation or misalignment.

By using an ILO in this way, the system of the present disclosure can be synchronised without the requirement of additional an out of band communication link. Therefore, complicated signal processing tasks are not required, and the apparatus can be comparatively simple. Additionally, the system has a high tolerance to misalignment and can operate under low coupling conditions and in highly dynamic environments due to the synchronisation of the oscillators in the active-active configuration. The bidirectional transceivers can be used in wide bandgap devices with extended frequency of operation (i.e., devices that operate at high frequencies). Wide bandgap devices may have bandgaps in the range above 2 eV. High frequencies may be in the MHz range.

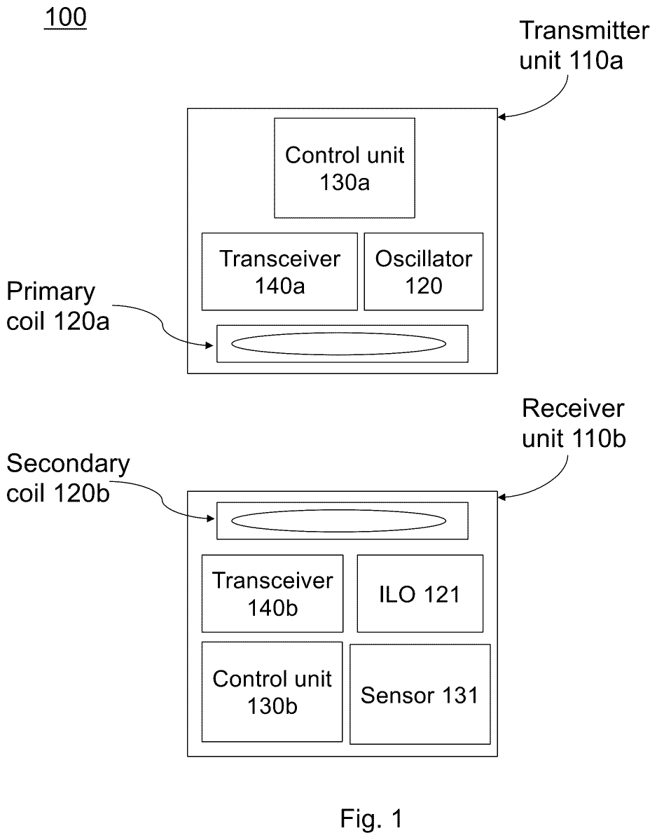

FIG. 1 depicts a block diagram of a wireless power transfer system 100 having two transceivers 140a, 140b. The wireless power transfer system comprises a transmitter unit 110a and a receiver unit 110b. The transmitter unit 110a comprises a first transceiver 140a coupled to a first inductive coil 120a, also called a primary coil 120a. In this example, the transmitter unit 110a also comprises a first control unit 120a and an oscillator 120. The receiver unit 110b comprises a second transceiver 140b coupled to a second inductive coil 120b, also called a secondary coil 120b, for inductive coupling with the first inductive coil 120a. The receiver unit 110b also includes an ILO 121, also called an injection-locked oscillator. In this example, the receiver unit 110b also comprises a second control unit 120b, and a temperature sensor 131. The first inductive coil 120a is inductively coupled to the second inductive coil 120b. The oscillator 120 may be a crystal oscillator and is provided to define the oscillation frequency of the first transceiver 140a. The ILO 121 defines the oscillation frequency of the second transceiver 140b and is configured to injection lock with the frequency of the first transceiver.

In the depicted example, the first transceiver 140a is part of the transmitter unit 110a, and so is switched to a transmit state, while the second transceiver 140b is part of the receiver unit 110b, and so is switched to the receive state. As the reader will understand, it may be possible to switch the first transceiver 140a (and hence the transmitter unit 110a) to a receive state; and it may be possible to switch the second transceiver 140b (and hence the receiver unit 110b) to a transmit state. Accordingly, the transmitter unit 110a may be called a first unit and the receiver unit 110b may be called a second unit. For the purposes of the present disclosure, a system is described in which the first transceiver 140a is configured in a transmission state, and the second transceiver 140b is configured in a receive state.

The oscillator 120 may be a crystal oscillator having an oscillation frequency which is similar to a natural oscillating frequency of the injection-locked oscillator 121.

The ILO 121 is provided to synchronize with a driving frequency of the transmitter unit 110a. The driving frequency of the transmitter unit 110a is the natural oscillation frequency of the oscillator 120. The synchronization may occur due to a fixed phase shift per oscillation cycle at the second inductive coil 120a, resulting in a constant frequency shift over time corresponding to the driving frequency of the transmitter unit 110a. The ILO 121 may be considered injection-locked when the oscillation frequency of the ILO (and hence the second transceiver 140b) matches the driving frequency of the oscillator 120 (and hence the first transceiver 140a).

When the second inductive coil 120b is inductively coupled to the first inductive coil 120a, such that the coupling between the transmitter unit 110a and the receiver unit 110b is sufficient to overcome the difference between a natural oscillating frequency of the ILO 121 and the driving frequency of the receiver unit 110b, the ILO 121 is pulled from the natural oscillating frequency of the ILO 121 to the driving frequency of the receiver unit 110b.

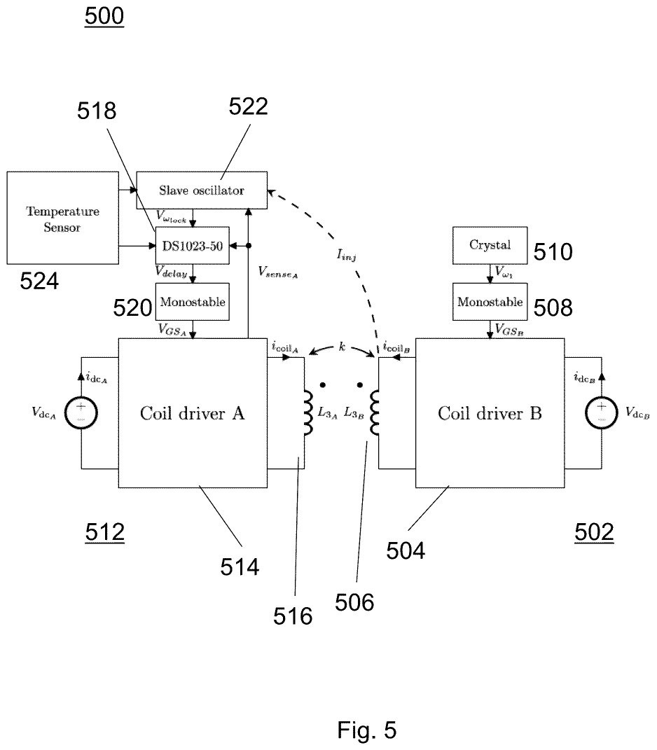

To transmit high power between the first inductive coil 120a and the second inductive coil 120b, a fixed phase close to +90° is required so that an induced voltage or induced power and the current in the second inductive coil 120b are in phase (i.e., no or minimal reflected reactance). A delay line (shown in FIG. 5) may be used to achieve a fixed phase close to +90°.

If an input voltage of the first inductive coil 120a is forced to short, the ILO 121 is still able to match the frequency of the current circulating in the first inductive coil 120a if a transistor in the first transceiver 140a is still switching at the desired frequency. This is because there is a small excitation current on the first inductive coil 120a to propagate the injection current at the required frequency in the injection-locked oscillator 121, stabilising and synchronising both sides of the system at the driving frequency. The driving frequency may then be called the injection-locked frequency.

FIG. 2 is a conceptual circuit diagram illustrating the principle of injection locking as used in the present disclosure.

The simple injection-locked oscillator 200 shown in FIG. 2 comprises an inductor L₁ 201, a capacitor C₁ 202, a resistor R_{P} 203, a transistor Q₁ 204, and an op-amp 205a forming a feedback loop 205b. A feedback current I_{OSC} is present in the feedback loop of the injection-locked oscillator and an injection current Iᵢₙⱼ is pulled from the feedback loop of the injection-locked oscillator due to the inductive coupling of the injection-locked oscillator with the oscillator 120 operating at the driving frequency. The injection current Iᵢₙⱼ has an injection frequency ωᵢₙⱼ. The injection-locked oscillator 200 pulls the frequency upon which the receiver unit 110b is operating to the frequency upon which the transmitter unit 110a is operating.

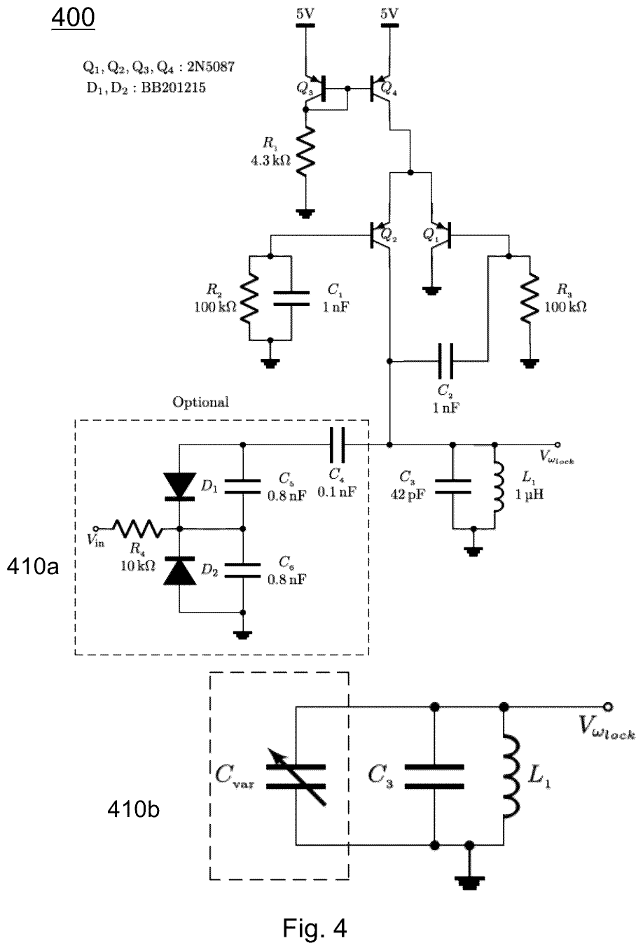

When the coupling between the natural oscillating frequency of the receiver unit 110b (i.e., the natural oscillating frequency of the ILO 200) and the natural oscillating frequency (or driving frequency) of the transmitter unit 110a is sufficient to overcome the difference between the first natural oscillating frequency and the driving frequency, the first natural oscillating frequency will be pulled to the second natural oscillating frequency. This frequency change induces fixed a phase offset between the receiver unit 110b and the transmitter unit 110a. The phase offset depends on a quality factor (Q factor) of the ILO and a frequency difference between the driving frequency and the natural oscillation frequency of the ILO. The ILO shown in FIG. 4 below has a Q factor of 86, for example.

The output of the injection-locked oscillator 200 is an injection-locked voltage V_{ω}_{_{lock}}. The injection-locked voltage V_{ω}_{_{lock}} is input fed back into the second transceiver 140b in order to define the oscillation frequency of the second transceiver 140b (and by extension the oscillation frequency of the receiver 110b).

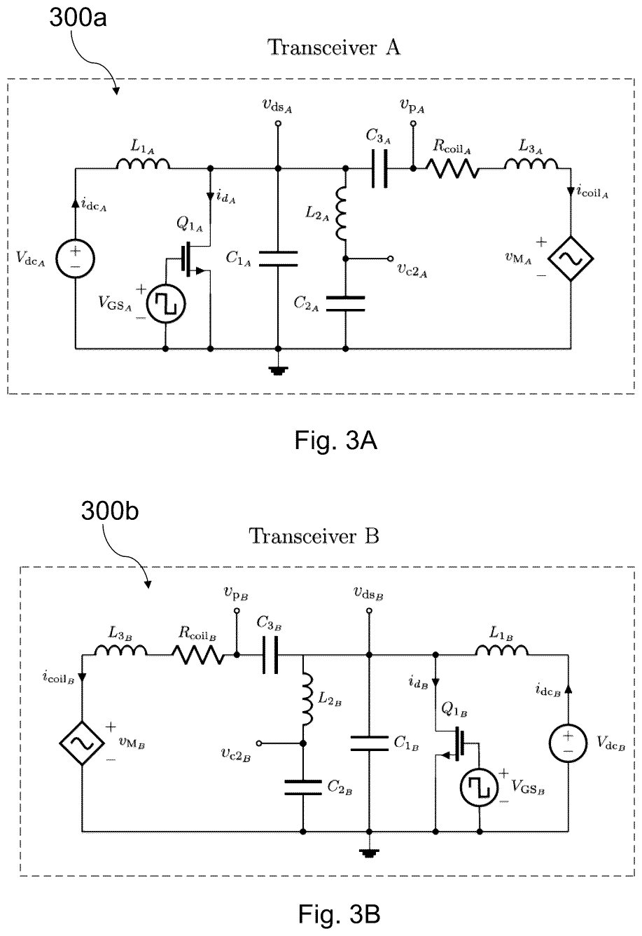

FIG. 3A depicts a circuit diagram of a first transceiver, transceiver A 300a, which may be used as the first transceiver 140a in FIG. 1. Transceiver A 300a is a class EF inverter. In particular, transceiver A 300a is a bidirectional Class EF inverter. In FIG. 3A, the transceiver load is modelled as a dependent voltage source V_{dcA}. The transceiver 300a is capable both of receiving wireless power (receiving mode) and transmitting wireless power (transmitting mode). The transceiver may be able to receive and store wireless power and then subsequently transmit power to another receiving device. As can be seen from FIG. 3B, the transceiver 300b has the same structure as the transceiver 300a. That is, it is an EF class inverter, which is configurable in a transmitting mode or in a receiving mode.

Each transceiver 300a, 300b comprises a first inductor L_{1A}, L_{1B} a second inductor L_{2A}, L_{2B}, and a third inductor L_{3A}, L_{3B}, and a first capacitor C_{1A}, C_{1B}, a second capacitor C_{2A}, C_{2B}, and a third capacitor C_{3A}, C_{3B}. Each transceiver 300a, 300b comprises a coil, represented in the circuit as resistance R_{coilA}, R_{coilB} which respectively correspond to the primary and secondary coils 120a, 120b of FIG. 1. Each coil R_{coilA}, R_{coilB} has a current i_{coilA}, i_{coilB} and a voltage v_{PA}, v_{PB}. A voltage v_{MA}, v_{MB} may be induced on each of the transceivers 300a, 300b. DC input power may be supplied to the transceiver with a DC input current i_{dcA}, i_{dcB} and input voltage V_{dcA}, V_{dcB}.

The drain voltage of transceiver A is depicted by v_{dsA}, and the drain voltage of transceiver B is depicted by v_{dsB}. A source-drain voltage waveform may be measured at a drain of a transistor, represented by Q_{1A} in for transceiver A and Q_{1B} for transceiver B. The transistor Q_{1A}, Q_{1B} may, for example, be a field effect transistor. The transistor current is represented by i_{dA}, i_{dB} and there is a gate to source voltage V_{GSA}, V_{GSB} which is the driving signal at the output of the gate drive. The EF branch capacitor voltage of transceiver A 300a is depicted by v_{c2A} and the EF branch capacitor voltage of transceiver B 300b is depicted by v_{c2B}. A drain voltage waveform and an EF branch capacitor voltage waveform are both examples of switching waveforms.

In use, transceiver A 300a may be used to transfer power wirelessly to transceiver B 300b. The oscillation frequency of transceiver A may be set by oscillator 120 in the system of FIG. 1. The oscillation frequency of transceiver B may be set by the ILO 121 in the system of FIG. 1. The respective oscillators may be connected where the voltage v_{MA}, v_{MB} is shown to be induced on each of the transceivers 300a, 300b.

The EF transceivers may be tuned to have load independence from one another. U.S. Pat. No. 10,170,940B2, which is incorporated herein by reference, describes from column 7 line 63 onwards how to achieve such load independence.

FIG. 4 depicts a circuit diagram of an ILO 400, which may be used as the ILO 121 in the system of FIG. 1. The injection-locked oscillator 400 comprises a first inductor L₁, a first capacitor C₁, a second capacitor C₂, a third capacitor C₃, a first resistor R₁, a second resistor R₂, a third resistor R₃, a first transistor Q₁, a second transistor Q₂, a third transistor Q₃, a fourth transistor Q₄, and a variable capacitance 410a or 410b. The first inductor L₁ may have an inductance of 1 μH, the first capacitor C₁ may have a capacitance of 1 nF, the second capacitor C₂ may have a capacitance of 1 nF, the third capacitor C₃ may have a capacitance of 42 pF, the first resistor R₁ may have a resistance of 4.3 kΩ, the second resistor R₂ may have a resistance of 100 kΩ, and the third resistor R3 may have a resistance of 100 kΩ.

The variable capacitance circuit used may be a varactor circuit 410a or a variable capacitor circuit 410b. The variable capacitance circuit may enable the natural oscillating frequency of the ILO 400 to be changed.

The varactor circuit 410a comprises a fourth capacitor C₄, a fifth capacitor C₅, a sixth capacitor C₆, a fourth resistor R₄, a first diode D₁, and a second diode D₂. The fourth capacitor C₄ may have a capacitance of 0.1 nF, the fifth capacitor C₅ may have a capacitance of 0.8 nF, the sixth capacitor C₆ may have a capacitance of 0.8 nF, and the fourth resistor R₄ may have a resistance of 10 kΩ.

The varactor circuit 410a and the variable capacitor 410b are optional and can be used to control the natural oscillating frequency of the injection locked oscillator 400. Effectively, the varactor circuit 410a acts as a variable capacitor 410b to control the resonant frequency of a tank comprising the first inductor L₁ and the third capacitor C₃ through an input voltage Vᵢₙ. This makes it easier to injection lock to the first unit 110a by bringing the natural frequency of the injection-locked oscillator 400 closer to that of the oscillator 120 in the first unit 110a, or producing a controlled phase offset of VGS in the second unit 110b.

An injected signal is injected from the transmitter unit 110a and is an additive emf to a voltage developed on the first inductor L₁. The injected signal and the developed voltage are fed back through a high pass filter comprising the second capacitor C₂ and the third resistor R₃ to the first transistor Q₁. The first transistor Q₁ is non-linear, so it generates a pulse current sequence at the collector of the first transistor Q₁. The sum of the collector currents of the first transistor Q₁ and Q₂ is constant, so the pulse current sequence having an opposite sign is applied to the tank comprising the first inductor L₁ and the third capacitor C₃.

The injection-locked oscillator 400 may be operated at a frequency of 13.56 MHz for a fixed input voltage of 60 V at both sides. The duty cycle may be fixed at 30%.

When ILO 400 is implemented as the ILO 130 in the system of FIG. 1, the output of the injection-locked oscillator 400 is an injection-locked voltage V_{ωblock}. The injection-locked voltage Vωlock is fed back into the receiver unit 110b. This stabilises the frequency and phase of the second transceiver 140b, and therefore the second unit 100b, thereby reaching a steady-state mode of operation.

In some embodiments, a delay module (shown in FIG. 5) is used at the output of the injection-locked oscillator 400 to change the phase V_{GS} relative to the primary coil current without affecting the natural frequency of the injection-locked oscillator 400. The delay module may be a DS1023-50 delay module. Optionally, a monostable circuit is positioned before the gate drive to ensure that the duty cycle is fixed at 30%.

FIG. 5 shows a further example of an IPT system 500 according to the present disclosure, having a transmission side 502 which comprises a first transceiver 504, a first coil 506, a first monostable circuit 508, and a first crystal oscillator 510. The system 500 also has a receive side 512 which comprises a second transceiver 514, a second coil 516, a delay module 518, a second monostable circuit 520, an ILO 522, and a temperature sensor 524.

On the transmission side 502, the oscillating voltage signal from the crystal oscillator 510 passes through the first monostable circuit 508 before being passed to the first transceiver 504 for defining an oscillation frequency of the first transceiver 504. This in turn drives the first coil 506 with a varying current i_{coilB}.

On the receive side 512, a current I_{coilB} is induced in the second coil 516. This induced current is passed to the second transceiver 514. The second transceiver 514 has its oscillation frequency set by the ILO 522. The signal from the ILO 522 is first passed to the delay module 518, and then to the monostable circuit 520, before finally being passed to the second transceiver 514 for defining the oscillation frequency of the second transceiver 514.

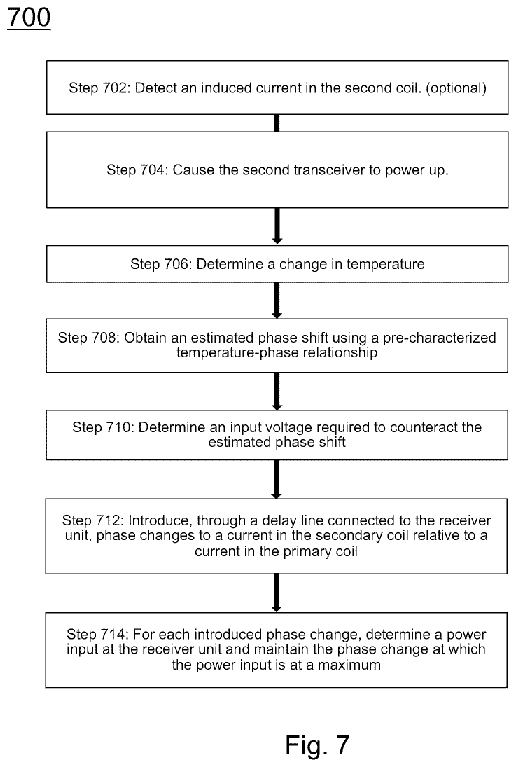

As shown in FIG. 5, a temperature sensor 524 is used to feed temperature information back to the system, and in particular to ensure that the ILO 522 and the delay unit 518 are operated to counteract any temperature-based changes on the receive side 512 of the system 500. More detail on temperature adjustments is provided in FIG. 7.

Finally, as also shown in FIG. 5, a feedback loop is present between the second transceiver 514, the first transceiver 504, the ILO 522, and the delay unit 518. It is this feedback loop which enables the ILO 522 to injection lock into the driving current I_{coilB} at the first coil 506 via injection current Iᵢₙⱼ.

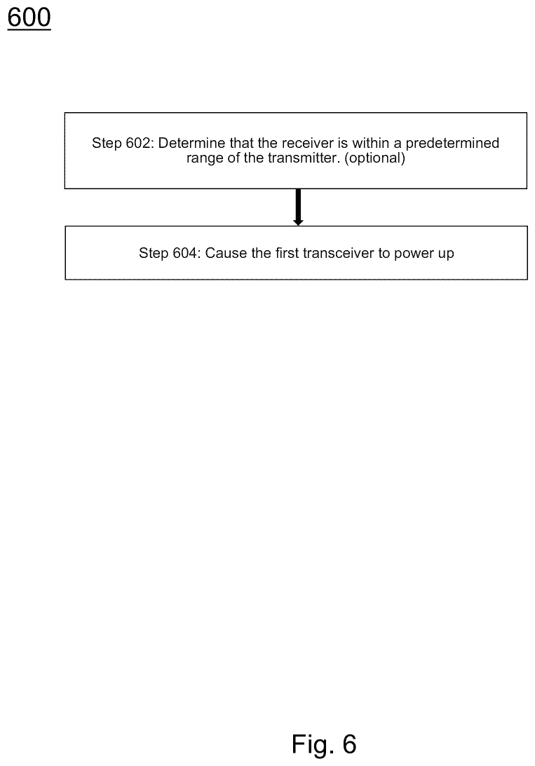

FIG. 6 is a flow chart showing a method 600 performed at a transmitter unit 110a from FIG. 1, for example at control unit 130a of the transmitter unit 110a. The method comprises causing the first transceiver 140a to power up at step 604. Optionally and prior to or after step 604, the method may comprise determining that the receiver unit 110b is within a predetermined range, for example within inductive coupling range, of the transmitter unit 110a at step 602.

FIG. 7 is a flow chart showing a method 700 performed at a receiver unit 110b from FIG. 1, for example at control unit 130b of the receiver unit 110b. The method 700 controls the receiver unit 110b for use in the inductive power transfer system 100, the receiver unit 110b comprising the transceiver 140b coupled to the inductive coil 120b, and the voltage-controlled injection-locked oscillator 121 coupled to the transceiver 140b for defining the oscillation frequency of the transceiver 140a. The method comprises causing the second transceiver 140b to power up at step 704. Optionally and prior to or after step 704, the method may comprise determining that there is an induced current in the secondary coil 120b of the receiver unit 110b due to induced coupling with the primary coil 120a of the transmitter unit 110a at step 702. At step 706, the method comprises determining, based on a signal from the temperature sensor 131 or 524, a change in temperature at the receiver unit 110b. More specifically, the change in temperature is of the oscillator 121 of the receiver unit 110b.

Temperature is one of the main factors that changes over time and can impact the operation of an oscillator of a system and can affect the operation of semiconductor devices used in the oscillator, even leading to changes in the natural frequency of oscillation which can result in unwanted injection of phase and complete loss of synchronisation due to a pre-characterized temperature-phase relationship. The injection of phase or produced phase offset between the primary and secondary coil currents can be characterized as an effect of a variation in voltage across the first and second diodes of the varactor circuit 410a and an effect of the temperature in proximity of the injection-locked oscillator. Critical changes in temperature may prevent injection locking.

At step 708, the method comprises obtaining an estimated phase shift using the pre-characterized temperature-phase relationship, for example from a pre-defined lookup table. In other words, a change in natural oscillating frequency of the injection-locked oscillator corresponding to the temperature change is determined. At step 710, the method comprises determining an input voltage required to counteract the estimated phase shift. This may also be described as determining a change in voltage required to counteract the change. The change in voltage or the input voltage required to counteract the estimated phase shift may then be applied to the injection-locked oscillator.

When the receiver unit 110b further comprises a delay line, at step 712, the method comprises introducing, through the delay line connected to the receiver unit 110b, phase changes to a current in the secondary coil 120b relative to a current in the primary coil 120a. These phase changes may be called phase perturbations which are introduced onto an oscillation signal sent to the transceiver 140b from the injection-locked oscillator 121.

For each phase perturbation, the method may comprise determining, based on an output from the transceiver 140b, a power output of the second transceiver 140a at the receiver unit 110b or an induced power at the receiver unit 110b, determining a phase perturbation at which the power output or induced power is largest, and controlling the delay line to maintain the phase perturbation at which the power output or induced power is largest. In other words, and at step 714, the method comprises, for each introduced phase change, determining a power input at the receiver unit 110b and maintain the phase change at which the power input is at a maximum.

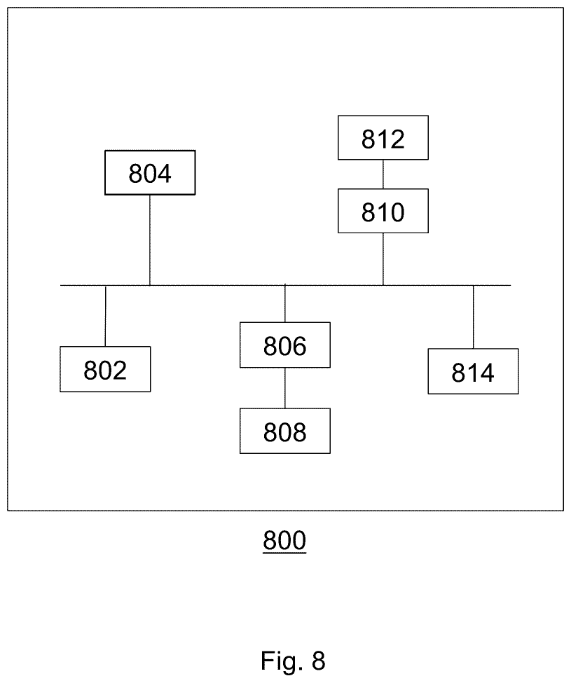

Turning finally to FIG. 8, FIG. 8 is a block diagram showing an example structure for control unit 130a or 130b.

The computer apparatus 800 comprises various data processing resources such as a processor 802 (in particular, a hardware processor) coupled to a central bus structure. Also connected to the bus structure are further data processing resources such as memory 804. A display adapter 806 connects a display device 808 to the bus structure. One or more user-input device adapters 810 connect a user-input device 812, such as a keyboard and/or a mouse to the bus structure. One or more communications adapters 814 are also connected to the bus structure to provide connections to other computer systems 800 and other networks.

In operation, the processor 802 of computer system 800 executes a computer program comprising computer-executable instructions that may be stored in memory 804. When executed, the computer-executable instructions may cause the computer system 800 to perform one or more of the methods described herein, such as the method of the second aspect, the method of the third aspect, the method of FIG. 6, or the method of FIG. 7. The results of the processing performed may be displayed to a user via the display adapter 806 and display device 808. User inputs for controlling the operation of the computer system 800 may be received via the user-input device adapters 810 from the user-input devices 812.

It will be apparent that some features of computer system 800 shown in FIG. 6 may be absent in certain cases. For example, one or more of the plurality of computer apparatuses 800 may have no need for display adapter 806 or display device 808. This may be the case, for example, for particular server-side computer apparatuses 800 which are used only for their processing capabilities and do not need to display information to users. Similarly, user input device adapter 810 and user input device 812 may not be required. In its simplest form, computer apparatus 800 comprises processor 802 and memory 804.

The above detailed description describes a variety of example arrangements for and methods of controlling IPT. However, the described arrangements and methods are merely exemplary, and it will be appreciated by a person skilled in the art that various modifications can be made without departing from the scope of the appended claims.

More generally, it should be appreciated that the number of steps shown in the figures is not intended to be limiting. Steps may be repeated as often as necessary and certain steps may be omitted.

The computer apparatus discussed above may be a local computer or a server.

While various specific combinations of components and method steps have been described, these are merely examples. Components and method steps may be combined in any suitable arrangement or combination. Components and method steps may also be omitted to leave any suitable combination of components or method steps.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

In an implementation, the modules, components, and other features described herein can be implemented as discrete components or integrated in the functionality of hardware components such as ASICS, FPGAs, DSPs, or similar devices.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features but does not exclude the inclusion of one or more further features.

The above implementations have been described by way of example only, and the described implementations are to be considered in all respects only as illustrative and not restrictive. It will be appreciated that variations of the described implementations may be made without departing from the scope of the disclosure. It will also be apparent that there are many variations that have not been described, but that fall within the scope of the appended claims.

Provided on the following pages, in the Appendix, is further information on the system according to the present disclosure, and its principles of operation. The information in the Appendix pertains to the presently disclosed aspects systems.

### Appendix: Synchronous Operation of High Frequency Inductive Power Transfer Systems Through Injection Locking

### Appendix Abstract

High frequency inductive power transfer systems can be designed for operation with high tolerance to misalignment and large air-gaps, making it possible to operate in highly dynamic environments. Most examples in the literature use a single active transmitter and a single passive receiver (active-passive approach). Such systems are limited to unidirectional power flow and are susceptible to detuning of the transmitter due to changes of reflected reactance stemming from diode non-linearities. This also limits the range of coupling over which the system can be operated efficiently. Therefore there is significant potential for expanding the range of applications of inductive power transfer systems by moving to an active-active configuration. This will enable bidirectional power flow, power routing through several nodes and on-the-fly retuning to eliminate reflected reactances. One of the greatest challenges in achieving an active secondary in an IPT system is obtaining a stable frequency and phase reference for the synchronous rectifier/transceiver with respect to the transmitter coil current and hence magnetic field. Various methods for synchronisation have been proposed in the literature, but they either require a separate, out of band communication link, or are difficult to scale to MHz operation. This paper describes an alternative to the existing solutions, using an injection locked oscillator to provide optimal phase tracking. A series of candidate feedback configurations are also proposed to provide high system resilience. In this work the basic principles of injection locking are described as applied to synchronous IPT transceivers and experimental results are presented demonstrating its application to a bidirectional back-to-back Class-EF configuration operating at 13.56 MHz, with coupling factors ranging from 1.9% to 8.4% and power levels of up to 25 W.

Index Terms Class—EF, resonant power converter, high frequency, wireless power transfer, synchronous rectification, injection locking

### I. Introduction

Inductive power transfer (IPT) has been an extensively growing topic of research in the past two decades. With the development of wide-bandgap devices, it has been possible to extend the possible frequency of operation to the Megahertz range for moderate power levels. Increasingly refined designs have been proposed to address challenges such as efficiency, coil separation distances and misalignment tolerance, leading to a higher number of applications for which IPT is a feasible solution, both in the kilohertz and the Megahertz range.

### A. Bidirectional Power Transfer and Power Routing

Whilst most of the literature to date presents designs that are restricted to unidirectional power flow from a single transmitting inverter to a single passive receiver rectifier (active-passive systems), operation of bidirectional systems has become a topic of increased interest. Reversible power flow capability, enabled through synchronous operation of both sides of the wireless link (active-active systems), opens up new opportunities for IPT in applications such as vehicle-to-grid and drone-rechargeable sensor networks.

Furthermore, the possibility of controlling the phase of the current in each transceiver coil for a fixed frequency reference can be used to enable applications where multiple nodes of an IPT system cooperate to route power and shape the magnetic field around the system. Applications that involve a network of cooperative and re-configurable transceivers can be beneficial in highly automated environments, such as factories, aerospace, or other applications where human intervention is limited.

In addition, due to the ability for an active-active system to self-tune, operation down to very low coupling factors, and hence applications which demand large air-gaps, is possible.

### B. Benefits of Synchronous Rectification at Low Coupling

High frequency inductive power transfer (HF-IPT) systems typically use air-core coils to achieve an unconstrained magnetic flux, hence making it easier to achieve efficient transfer of power for large distances and with a large tolerance to misalignment. It is even possible to design such systems for a large tolerance to load variations.

While it is possible to achieve high efficiency under a large set of operating conditions there are still existing constraints in the development of HF-IPT systems: passive rectifiers are typically a common choice because of their simplicity and achievable efficiency, however the characteristics of their reflected impedance back to the primary can be heavily affected by the magnitude of the induced voltage of the secondary (because of the non-linear diode capacitance), hence making it more challenging to tune a system for this wide range of operating conditions. In addition, low coupling operation can lead to extra losses: the induced voltage in the secondary coil reduces with a decrease in coupling factor. For a fixed power level it is then necessary to have larger currents, increasing the losses when employing a passive rectifier due to the constant voltage drop across the diodes.

Synchronous rectification addresses both of these issues: the voltage drop across a conducting transistor is typically small compared to the voltage drop across a diode, hence the losses would be lower. In a synchronous rectifier it is also possible to control the phase between primary and secondary, hence making it possible to track a state of zero-reflected-reactance for optimal operation as the coupling changes.

A performance comparison between an active-passive and active-active configuration for Megahertz IPT system proves that even for frequencies as high as 27.12 MHz a synchronous rectifier can be advantageous in terms of end-to-end efficiency.

### C. Challenges in Transceiver Synchronisation at Megahertz

One of the main challenges in operating a synchronous or a bidirectional HF-IPT system is clock synchronisation of the two sides of the system: if there is a frequency mismatch between primary and secondary, it is not possible to operate under a fixed relative phase. To transmit real power between primary and secondary, a fixed phase close to ±90° is required so that the induced voltage and the current in the secondary resonator are in phase (i.e., no reflected reactance). If a constant phase slip is introduced between the currents in the primary and secondary as a result of a frequency mismatch between the two sides, it will result in an average power transmission of zero.

Solutions for synchronisation have been proposed for low frequency and high frequency active systems. Nevertheless, some of them are difficult to apply to Class EF-based HF-IPT systems because of the circuit configuration and/or the required instrumentation bandwidth for a high frequency counterpart. An additional coil to measure the current may be required, which is feasible for applications at this frequency range, but it introduces additional elements in the inverter, hence leading to a potential alteration in the topology of the resonant link because of parasitics. A method that only works in specific conditions may be proposed, where the system will operate for a fixed on-time to achieve zero-voltage switching, but the off-time will change. This means that the system is effectively performing a dynamic frequency tuning with variable relative duty cycle. This can sometimes lead to instability. An auxiliary communication link may be used.

A possible alternative to tackle some of the difficulties highlighted above is presented, where a separate communication link is not required, it is not necessary to carry out complicated signal processing tasks, and the proposed method allows operation under extremely low coupling conditions. This is achieved using an injection locked oscillator, hence making it possible for the secondary side of the system to naturally converge to the operating frequency of the primary at a fixed relative phase offset.

It is illustrated how this can also be used in conjunction with other techniques to track and correct the optimal phase and achieve closed loop control of the system. Experimental results show the start-up behaviour of the system, the effect of temperature on the oscillator's behaviour and stable system operation for different operating conditions, with power levels of up to 25.7 W.

Section II provides an overview of Class EF transceivers, and how they are operated for bidirectional power transfer. Section III describes the basic principles of injection locking, and how this can be used in a HF-IPT system to achieve synchronous rectification. Section IV presents the experimental results obtained by operating a bidirectional 13.56 MHz IPT system based on a back-to-back Class EF configuration. Section V explains how it is possible to implement a closed loop configuration to improve the reliability of the system for different operating conditions. Section VI concludes the paper.

### II. Implementing Class Ef Transceivers for Bidirectional Wireless Power Transfer

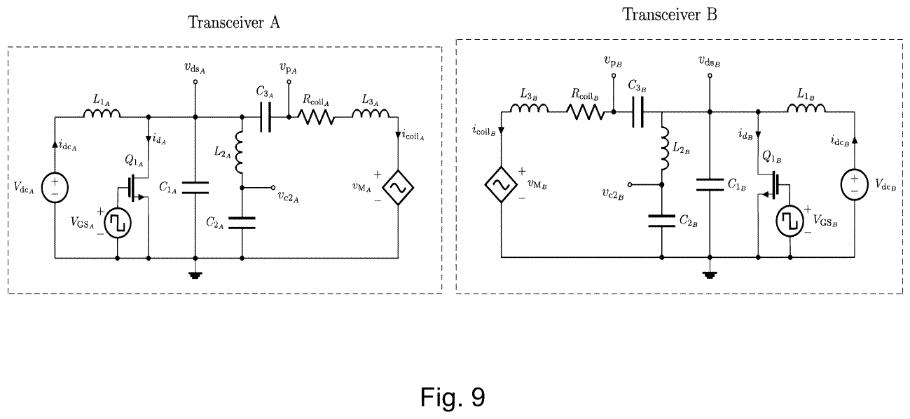

The Class EF topology, shown in FIG. 9 in a back-to-back bidirectional configuration, is a coil driver which is often employed in IPT systems operating in the Megahertz range. This topology comprises just a single low-side switch, making it easy to drive, and is typically operated in open loop with a fixed frequency and duty cycle. The Class EF shares multiple similarities with a Class E coil driver, but the addition of an extra LC branch makes it possible to obtain an extra degree of freedom in the design. This can be used to shape the drain waveform, lowering its peak voltage (hence reducing the stress on the device) or to achieve desirable system properties such as load independence by relaxing design constraints exclusively to zero-voltage-switching (ZVS).

In the specific context of this work, the Class EF load independent topology is useful because it introduces additional system tolerance in terms of load variations, which can be beneficial either when the coupling changes, or when the phase-search algorithm is being performed, ensuring safe transceivers operation for a wide range of loading scenarios.

This topology can be arbitrarily used as an inverter or a rectifier, with the only difference being the relative phase between transmitter and receiver coil currents: keeping this phase at ±90° ensures operation of each side of the system as transceivers capable of exchanging power with no reflected reactance.

The component values used in this work for Transceiver A and Transceiver B (FIG. 9) are reported in Table I. The two sides are both tuned to achieve load independence, although the exact component values are slightly different due to parts shortage. Further details on how to select components and system parameters (such as duty cycle and input voltage) for the Class EF load independent topology are reported. This tuning arrangement has been specifically chosen, as it produces a near-constant coil current in a wide load range.

TABLE I
COMPONENTS VALUES FOR TRANSCEIVER A
AND TRANSCEIVER B. CLASS EF TRANSCEIVERS,
V_{dc} = 60 V, δ = 30%,
PLANAR PCB COILS ON BOTH SIDES.

| | Transceiver | Transceiver | |
|---|---|---|---|
| Component | A | B | Description |
| C₁ (pF) | 100 + Cₒₛₛ | 92 + Cₒₛₛ | Vishay QUAD HIFREQ |
| C₂ (pF) | 186 | 200 | Vishay QUAD HIFREQ |
| C₃ (pF) | 125 | 136 | Vishay QUAD HIFREQ |
| L₁ (μH) | 88 | 88 | Wurth Elektronik WE-PD |
| L₂ (nH) | 234 | 251 | Collcraft 2014VS |
| L₃ (nH) | 1181 | 1181 | IPT PCB coils |
| Q₁ | | | GS66504B (650 V, |
| | | | 15 A) GaN FET |

In this work the transceivers are operated at a frequency of 13.56 MHz to exploit the improvement in quality factor of air-core coils in the Megahertz range, hence achieving an unconstrained magnetic flux, which can be useful to achieve efficient operation for larger distances and with larger tolerance to misalignment. Other Megahertz ISM band frequencies (such as 6.78 MHz) could also be used with these coils.

### III. Basic Principles of Injection Locking

Injection locking is a phenomenon that has been studied since 1946. The core idea of injection locking is that under some specific circumstances, it is possible to synchronise the frequency of two independent oscillators, provided that coupling between two oscillators is present and the natural oscillating frequencies of the oscillators are somewhat close (i.e., operating within the lock range as per Equation 13).

If the coupling between an oscillator with a natural oscillating frequency of ω₀ (slave side) and an oscillator with a natural oscillating frequency of ω₁ (master side) is sufficient to overcome the difference ω₀−ω₁, it is possible to pull the oscillator from a frequency of ω₀ to a frequency of ω₁.

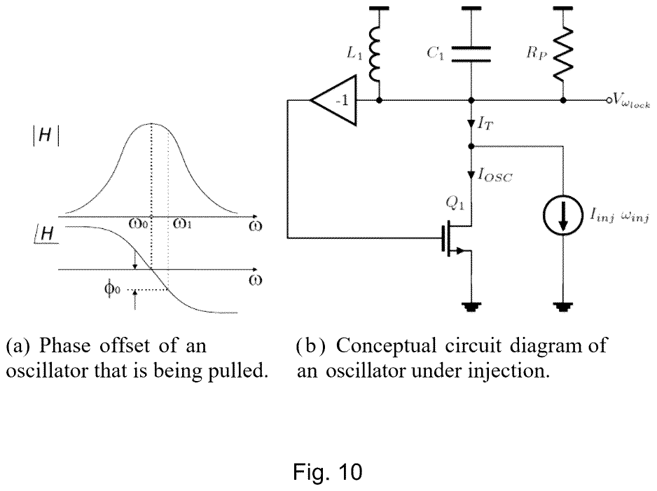

This comes with an inherent phase offset which depends on quality factor and frequency difference as summarised in FIG. 10, where I_{osc} is the current present in the feedback loop of the oscillator that is being injection locked and Iᵢₙⱼ is the current pulled from the feedback loop of the oscillator as a consequence of the coupling with the system operating at a frequency of ω₁.

The lock range of an oscillator ω_{L} can be obtained. A second order resonant tank like the one illustrated in FIG. 10 exhibits a phase shift a when oscillating at a frequency ω₁, in vicinity of its resonance ω₀:

$$α = \frac{π}{2} - {tan}^{- 1} ( \frac{{L}_{1} {ω}_{1}}{{R}_{P}} \cdot \frac{{ω}_{0}^{2}}{{ω}_{0}^{2} - {ω}_{1}^{2}} ) \qquad ( 1 )$$

It is possible to approximate

$${ω}_{0}^{2} - {ω}_{1}^{2} \approx 2 {ω}_{0} ( {ω}_{0} - {ω}_{1} )$$

and rewrite L1ω₁/RP=1/Q and π/2−tan-1x=tan-1(x−1):

$$tan α \approx \frac{2 Q}{{ω}_{0}} ( {ω}_{0} - {ω}_{1} ) \qquad ( 2 )$$

When the oscillator experiences the effect of the injection current Iᵢₙⱼ, Iᵢₙⱼ and I_{osc} will exhibit an angle of φ₁+φ₂, with φ₁ being the angle between Iᵢₙⱼ and I_{T} and φ₂ being the angle between I_{T} and I_{osc}. When ωᵢₙⱼ (or ω₁) departs from ω₀ the phase shift introduced by the tank increases together with the angle φ₂. This implies a counterclockwise rotation of I_{osc}. It is possible to write:

$$sin ( {ϕ}_{2} ) = \frac{{I}_{inj}}{{I}_{T}} sin {ϕ}_{1} = \frac{{I}_{inj} sin {ϕ}_{1}}{\sqrt{{I}_{OSC}^{2} + {I}_{inj}^{2} - 2 {I}_{OSC} {I}_{inj} cos {ϕ}_{1}}} \qquad ( 3 )$$

To find the lock range this expression is maximised, leading to sin φ_{2,max}=Iᵢₙⱼ/I_{osc} when cos φ₁=−Iᵢₙⱼ/I_{OSC}. This translates in an angle of 90° between Iᵢₙⱼ and I_{T}. Hence it is possible to write

$$tan {ϕ}_{2} = {I}_{inj} / {I}_{T} and {I}_{T} = \sqrt{{I}_{OSC}^{2} - {I}_{inj}^{2}} .$$

Using this information in conjunction with Equation 2 (setting α=φ₂) it is possible to write:

$${ω}_{L} = {ω}_{0} - {ω}_{1} = \frac{{ω}_{0}}{2 Q} \cdot \frac{{I}_{inj}}{{I}_{osc}} \cdot \frac{1}{\sqrt{1 - \frac{{I}_{inj}^{2}}{{I}_{osc}^{2}}}} \qquad ( 4 )$$

When approaching the edge of the lock range (i.e., Iᵢₙⱼ<<I_{osc}) this is approximately:

$${ω}_{L} \approx \frac{{ω}_{0}}{2 Q} \cdot \frac{{I}_{inj}}{{I}_{osc}} \qquad ( 5 )$$

This property can be advantageous, especially in the context of synchronous rectification, where a switching signal needs to be generated in quadrature with that of a master. Changing the natural oscillating frequency of such an oscillator can hence serve two purposes: facilitate injection locking over a wider range, or provide a set phase offset. As will be discussed in Section V, the way the phase offset is controlled, either by changing ω₀ or introducing an external delay, depends on the circumstances.

From (5) it is clear that to maximise ω_{L}, it is necessary to have a large magnitude of Iᵢₙⱼ, especially when trying to pull an oscillator with a high quality factor. The non-linearity of the oscillator is another key component, as a perfectly linear oscillator with a high quality factor would not be pulled by the means of injection locking.

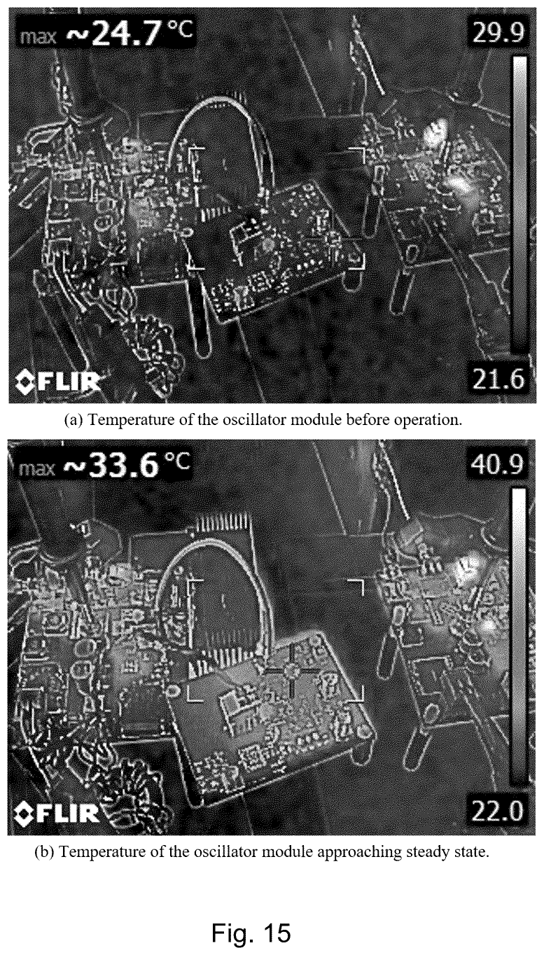

Failure in synchronisation was monitored with the experimental setup for distances between primary and secondary coils of more than 35 cm (almost two coil diameters): the system entered quasi-locking, showing a characteristic phase slip at regular intervals of around half a second. For distances higher than 40 cm frequency locking is lost completely, implying that the system is operating well beyond the established lock range ω_{L}. An example of typical phase slip behaviour caused by quasi-locking is reported in FIG. 15.

We have observed injection locking occurs even when lowering the input voltage of the two transceivers to around 10V, with corresponding coil currents of around 500 mA, but no useful exchange of power (i.e., the losses were higher than the transferred power, but the coil currents were synchronised).

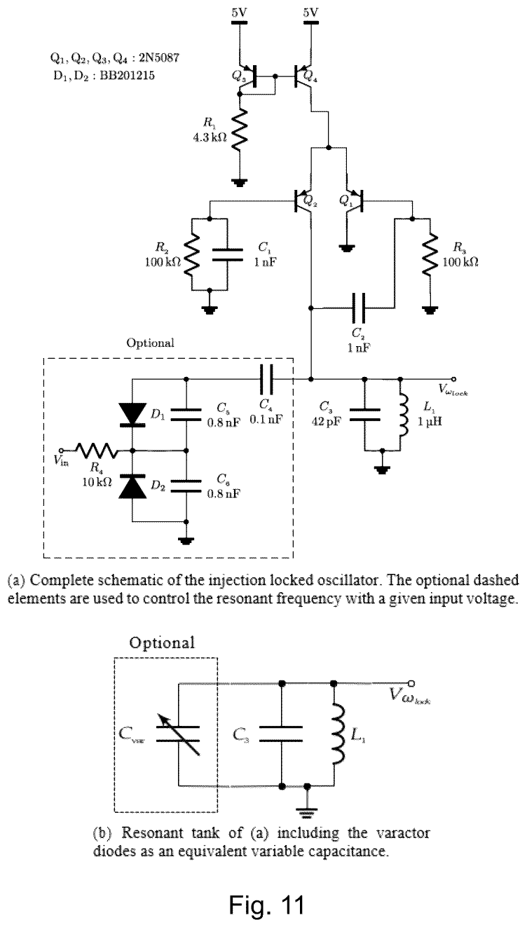

The lock range is dependent on the magnitude of the injection current (see Equation 5), and hence the separation between the two sides of the system. For a coil separation of 25 cm, the lock range of the oscillator is estimated to be around 60 kHz. Using the ring-down method, the quality factor of the oscillator in FIG. 11 is estimated to be around 86, with a corresponding I_{osc}=1 mA.

One matter that arises from employing injection locking in an IF-IPT systems is the possibility of simply synchronising independent crystals using the same principle. While this is possible in theory, this task can prove rather challenging in practice: the high quality factor of the crystals, together with a relatively small packaging which minimises the coupling with the injection current make it difficult to simply synchronise the two sides of the system without using a dedicated oscillator that has been specifically designed for the task. In this work this task is attempted using the experimental setup of Section IV. Even when placing the coil of the master side directly above the crystal of the slave side, our attempts at pulling an independent SG-210 STF CMOS oscillator proved unsuccessful.

### IV. System Design and Experimental Results

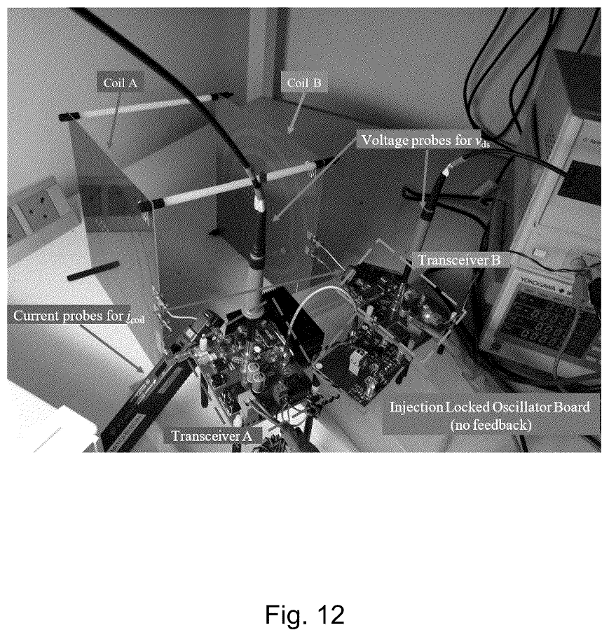

The system (shown in FIG. 12) consists of two back-to-back Class EF transceivers connected as shown in FIG. 9: the input voltage of each of the two sides of the system is provided through a source-sink configuration of an electronic load in constant voltage mode (the sink) operated in parallel with a power supply (the source). This makes it possible to obtain the same input voltage for each side of the system, while enabling the possibility of bidirectional operation.

The link consists of two PCB planar coils (two-turns, with an external diameter of 20 cm), with an inductance of 1.18 μH and a quality factor of more than 500 at 13.56 MHz. More details on coils design and characterisation are reported. These coils are chosen for ease of reproducing the experiment and accurately controlling the separation between the coils. In this work the variations in coupling factor are achieved solely by changing the distance between the two coils (z-direction), but it is in principle possible to replicate the same results through the choice of an appropriate misalignment in the x-direction and y-direction.

Table I summarises the components for the two transceivers. One of the two sides of the system (the master) uses a crystal oscillator to generate VGS, while the other side (the slave) uses the oscillator in FIG. 11 to match the frequency of the master through injection locking as explained in Section III. This works similarly to a pMOS differential LC oscillator, with the only difference being that one of the two sides of the tank is grounded. The optional circuitry presented in FIG. 11 can be used to control the natural oscillating frequency of the injection locked oscillator. Effectively, the varactors act as a variable capacitance to control the resonant frequency of the tank through an input voltage Vᵢₙ.

This makes it easier to injection lock to the master by bringing the natural frequency of the oscillator closer to that of the crystal on the master, or producing a controlled phase offset of V_{GS} on the slave side.

If the latter makes it unfeasible to achieve injection locking because the slave side is being pushed into quasi-locking, or if the system is being operated without the optional circuitry, it is possible to use a delay module at the output of the oscillator to change the phase of V_{GS} relative to the transmit coil current without affecting the natural frequency of the oscillator. This has been verified experimentally using a DS1023-50 delay module. The stage before the gate drive is always a monostable circuit to make sure that the duty cycle is fixed at 30%.

The system is designed by setting a resonant tank frequency through a selection of DC_{3,4,5,6} and L₁. This combination is set to ensure a change in resonant frequency from 13.5 MHz to 13.6 MHz with a corresponding change in Vᵢₙ from 0V to 5V as a consequence of the change in capacitance of the varactors D_{1,2}.

The circuit in FIG. 11 works as follows: the injected signal is an additive emf to the voltage developed on L₁. The two are fed back through the high pass filter C₂-R₃ to Q₁ which is non-linear, so it generates a pulse current sequence at the collector of Q₁. As the sum of the collector currents of Q₁ and Q₂ is constant, the pulse sequence, but of opposite sign is applied to the tank L₁-C₃. A detailed explanation of the pulling and locking mechanism has been given.

The system is operated at a frequency of 13.56 MHz for a fixed input voltage of 60V at both sides, and with a fixed duty cycle of 30%.

When both sides of the system are simultaneously switched on, the master will start producing a coil current at the frequency of its crystal oscillator. After a couple of cycles, the magnetic field generated by this current will be large enough to pull the oscillator circuit on the slave side to the frequency of the master, which will then stabilise its frequency and phase, hence reaching steady-state. For practicality, it is assumed that both sides have enough energy to bootstrap the system. In actual facts it does not matter which side of the system is turned on first or whether the master resides with the transmitter or the receiver.

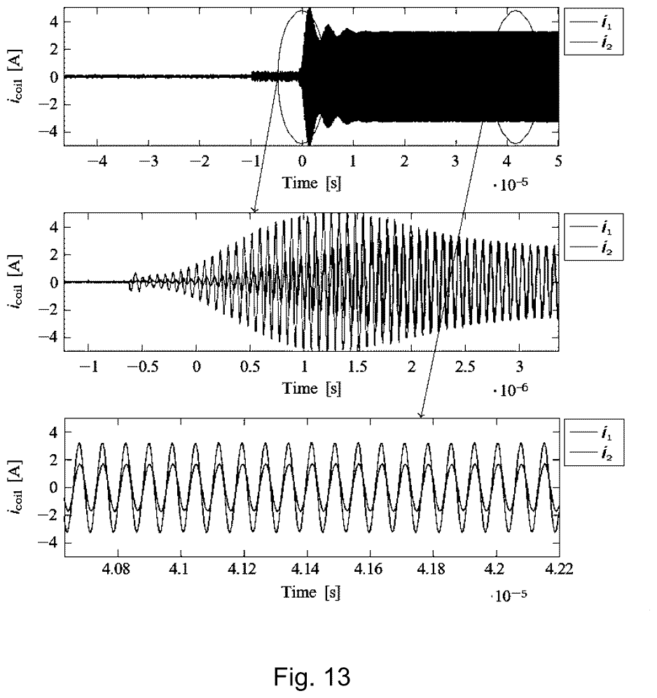

This process is summarised in FIG. 13, in which the details of the coil currents in each of the two sides of the system are shown, with the master in blue and the slave in orange. In this specific scenario the system has been set up to have a phase offset of zero to facilitate the visualisation of a successful phase lock, but in practice it will typically be operated with a phase offset between primary and secondary coil currents of ±90°. Frequency and phase lock occur after a transient of less than 30 μs.

While in this work a dedicated coil to synchronise the slave side oscillator is not present, it is in principle possible to add this element to facilitate the process of injection locking. In this work the unconstrained magnetic field from the link can generate the required injection current on the oscillator board without the need of additional elements.

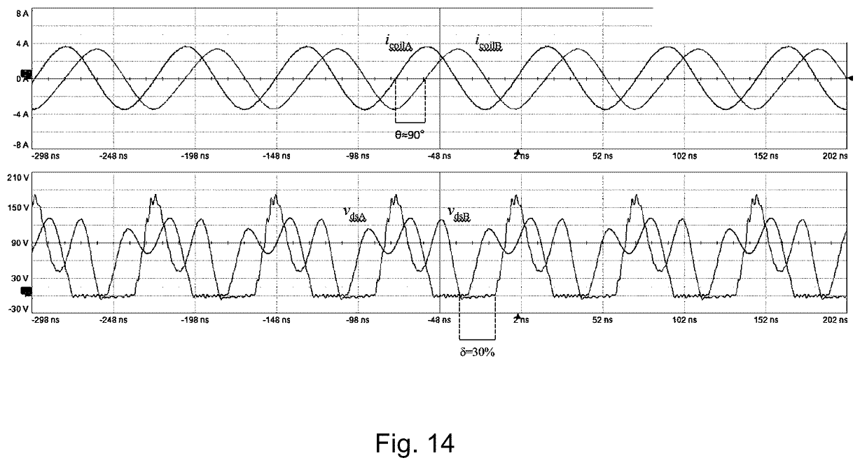

FIG. 14 shows a scope capture of the system operating with the required phase offset of ±90° for optimal power transfer efficiency. The coil currents (top waveforms) show that the required phase offset is achieved. The reported drain voltage waveforms on the bottom show soft switching is achieved in both transmitter and receiver side.

It is possible to exploit the phenomenon of injection locking even with passive rectifiers, so that the frequency of the primary matches the resonant frequency of the secondary for optimal power transfer efficiency. Similarly, in the proposed system, when the input voltage of the master side is forced to short or open, the injection locked oscillator on the slave side will still manage to match the frequency of the current circulating in the primary coil, provided that the transistor on the master side is still switching at the desired frequency: if there is a small excitation current on the master side coil, this will propagate an injection current at the correct frequency in the oscillator of the slave side, stabilising both sides of the system at a matched frequency.

When the system is operated without a master side in proximity, the oscillator will just oscillate at its natural frequency and the transceiver will still work correctly, since the natural frequency of the oscillator is designed to be relatively close to that of the operating system.

Table II shows input and output power for different operating conditions. It is possible to reliably transfer power down to a coupling of 1.9%, and synchronisation is not lost until the coupling is lower than 0.9% (35 cm separation). For a coupling of 4.5% it is possible to transfer 13.7 W with a 53.7% end-to-end efficiency. For higher coupling and power levels these figures tend to be higher: the standby power of the design implemented in this work is around 4 W per side. The efficiency is measured by monitoring the power at both ends of the system using a Yokogawa WT332E Digital Power Meter.

TABLE II
SYSTEM OPERATION FOR DIFFERENT
COILS SEPARATIONS

| Distance | | Phase | I/P Power | O/P Power | η_{DC-DC} |
|---|---|---|---|---|---|
| [cm] | k [%] | [°] | [W] | [W] | [%] |
| 30 | 1.2 | 89 | 12.1 | 0.9 | 0 |
| 25 | 1.9 | 89 | 14.4 | −3.2 | 22.2 |
| 20 | 3.1 | 88 | 20.6 | −9.2 | 44.7 |
| 17.5 | 4.5 | 90 | 25.5 | −13.7 | 53.7 |

Low-efficiency/low-coupling scenarios have been specifically addressed to further validate the applicability of the proposed approach under difficult conditions.

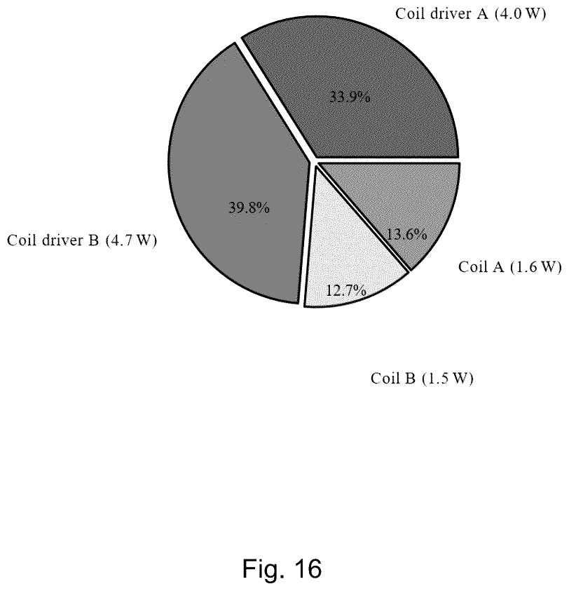

A breakdown of the losses for the 4.5% coupling scenario is presented in FIG. 16.

A crucial task to operate this type of system reliably for any given external environment is the design of a feedback loop. While the previous section demonstrated system operation in open loop, there is a wide range of factors that can affect the operation of the system, leading to possible sub-optimal operation or even failure of the system as a whole.

Temperature is one of the main factors that changes overtime and can impact the operation of the system: as shown in FIG. 15, the oscillator module's operating temperature can change by up to 10° C. in a controlled environment (even more when deployed in the field). This can affect the operation of the semiconductor devices used in the oscillator, even leading to changes in the natural frequency of oscillation (and the lock range as per Equation 5). The consequences of this can range from an unwanted injection of phase to complete loss of synchronisation: as explained in Section III as the natural frequency of the oscillator gets further apart from that of the master side, the phase will change. Also, the required magnitude of the injection current will grow larger.

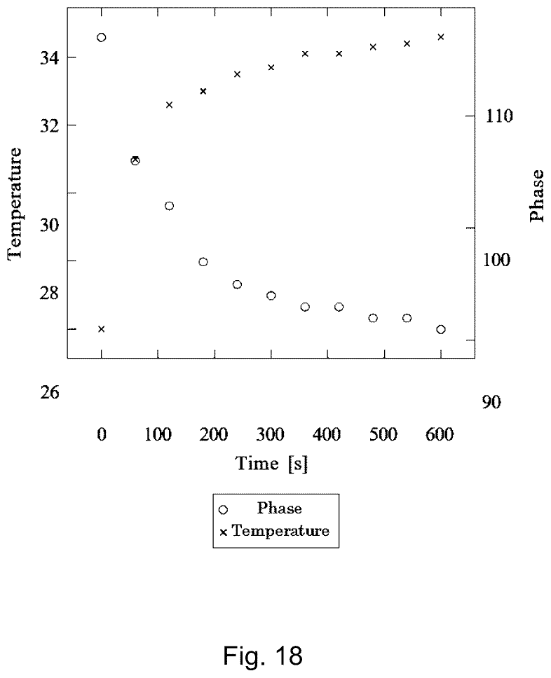

In FIG. 18 it is possible to observe how over a time span of 10 minutes the temperature has gone up by almost 10° C., and the phase has gone down by 30°. This is something to avoid in an operating system. A closed loop feedback system can mitigate this problem.

### V. Closed Loop Operation

A method, which consists of a technique to estimate the reflected impedance in a Class EF system, could be implemented to solve this issue: a reference voltage level would be provided to monitor the reflected reactance and the relative phase offset could then be adjusted accordingly. However there is a practical consideration to make: this method is based on the extraction of information at a single frequency, but the system presented in this paper has an oscillator with a frequency that might change during the adjustment in the feedback loop or when synchronisation is lost.

Designing the same system with filters that have a wider bandwidth would solve part of the problem, but the required filter transfer function would need to be extremely flat over the operating frequency range. It has been observed experimentally that this method works when the system is already in a stable state, and hence the frequency remains fixed, but it would be otherwise impossible to use the reflected impedance estimation technique to lock the oscillator when starting the system from an unstable state: two slightly different operating frequencies can lead to the same reference voltage value for the reflected impedance estimation as a consequence of the filters response not being constant over the operating range.

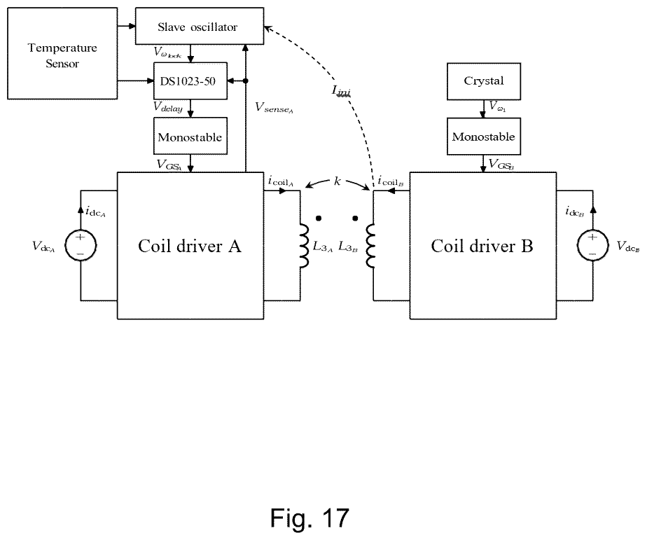

A simpler alternative is to perform phase control (or natural oscillating frequency control) of the slave oscillator through a direct measurement of the factors that may affect injection locking. While temperature is possibly one of the easiest to observe, other factors can be ambient EMI, humidity, light and radiation. In this work the feedback loop is only based on temperature, but it is in principle possible to monitor the other aforementioned factors employing appropriate sensors. This correction can be done as shown in FIG. 17 using a lookup table to perform the desired correction to either the oscillating frequency or the phase.

It is known from Section III that affecting the natural oscillating frequency of the oscillator will also affect the phase at which injection locking occurs, but it will also change the locking range (as reported in (5)). This implies that in some scenarios where all the corrections are applied through the input voltage Vᵢₙ of the VCO in FIG. 11, the lock range could be decreased to a critical level that would prevent injection locking.

For this reason the only adjustments that should be performed through Vᵢₙ are the ones to counteract the change in natural oscillating frequency of the oscillator (such as temperature). Other corrections applied to account exclusively for a shift in phase, but not oscillating frequency, (i.e., fine tuning of the system or changes in reflected reactance from a coupled resonant circuit) should be performed through the delay module, so that the optimised locking range remains unaffected.

This allows operation of the system for relatively stable values of ω₀ and ω_{L}, hence providing higher rejection of disturbances from external sources, improving the resilience of the system.

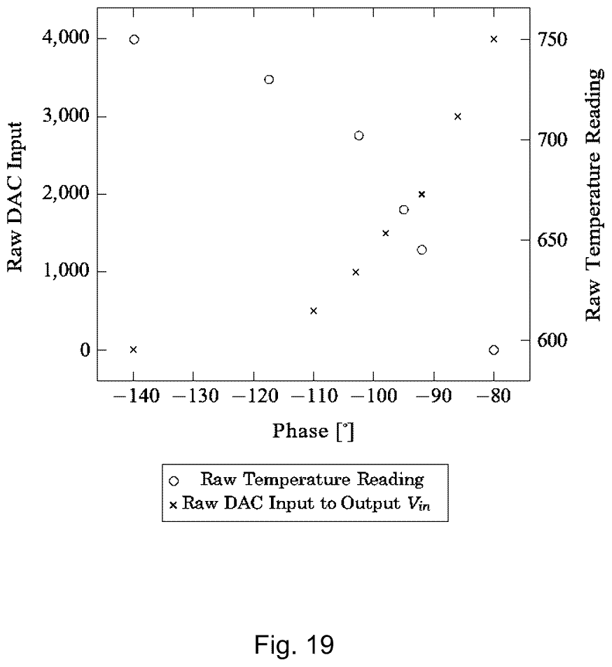

The feedback to provide the required adjustments of ω₀ in response to temperature variation is designed by characterising the produced phase offset between coil currents as an effect of a variation in the voltage across the varicap diodes (Vᵢₙ) and as an effect of the temperature in proximity of the custom oscillator of FIG. 11 using a PT100 temperature sensor. Using a combination of these two experimentally derived relationships (shown in FIG. 19) it is possible to create a lookup table to correct the phase offset produced by the temperature variation by changing the value of Vᵢₙ, and hence ω₀ and the phase between the coil currents.

An additional step to improve the resilience of the system is an extra feedback loop to perform phase correction through the delay module in response to possible detuning of the system. This can be done using a MPP tracking algorithm to maximise the power received by the slave side of the system. Since the input voltage of the transceivers is constant in this design, the received power is estimated using the receiver current, which is measured using a current sensor. The phase between coil currents will converge to a value close to −90° for minimum reflected reactance on the receive side and maximum received power. Bidirectional power transfer can be achieved by simply introducing a phase offset of 7 using the delay module.

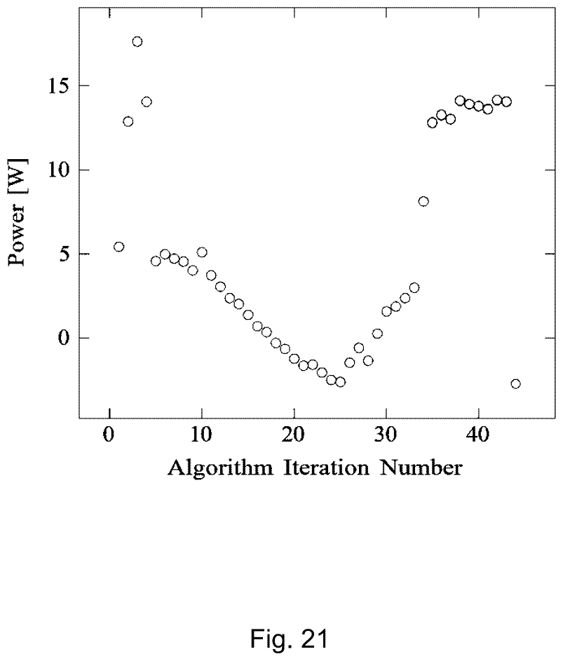

The synchronisation process is summarised as follows:
1. Read the temperature to obtain a value for the estimated phase shift solely as a result of the temperature change (i.e., phase difference because of pre-characterised temperature-phase relationship from FIG. 21).
2. Change the input voltage of the VCO according to the pre-characterised DAC input-to-phase relationship to counteract possible changes in oscillator's natural frequency based on the estimated phase difference from the temperature reading. These two steps can be merged using a look-up table to directly translate a temperature reading into a microprocessor output to the DAC: for example if the temperature reading indicates an estimated phase that is 30° lower than expected, the DAC will produce the corresponding VCO voltage value to introduce a 30° phase shift in the opposite direction. For this reason the DAC is initially set to a value with equal headroom and legroom to produce the required corrections. This is done using the data in FIG. 21 and performing interpolation for the intermediate points.
3. Start introducing phase changes through the delay line and find the point at which the received power is the highest.
4. Convergence is achieved.
5. Keep monitoring the temperature and correct the input voltage of the VCO at regular intervals to prevent phase injection from temperature changes.
6. Keep the two points adjacent to the current operating point for maximum received power and adjust the delay line accordingly.
7. Repeat steps 5 and 6 to ensure the appropriate phase is maintained.
8. (Optional) Add a further phase shift of π if the direction of the system power flow needs to be reconfigured.

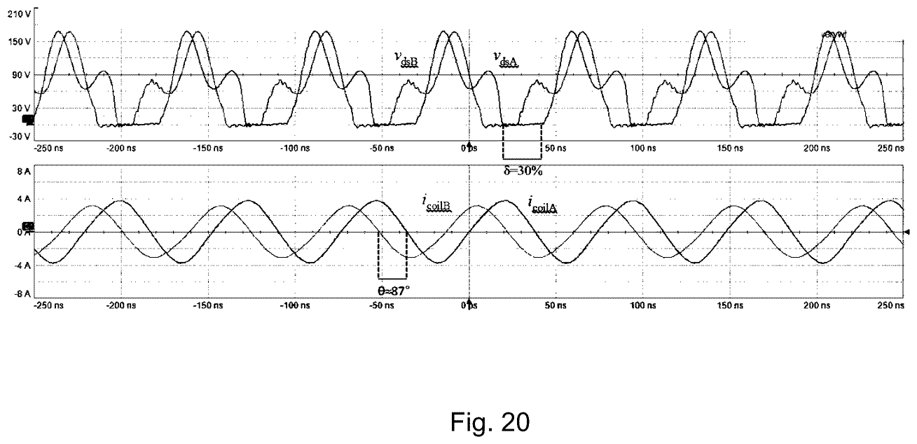

It is still possible that the transmitter will operate sub-optimally under these circumstances as a result of possible tuning mismatches between the two sides: the transmitter can still operate under non-zero reflected reactance as shown in FIG. 20. In this experiment the system has been purposely pushed above the power level for which it was designed. From FIG. 20 it is in fact possible to observe that while the receiver's drain voltage waveform is soft-switching as expected, the transmitter is hard-switching, carrying most of the losses of the end-to-end system, but minimising losses on the receive side.

The losses could be balanced if the system was designed to optimise for maximum efficiency, rather than using only the information on the receiver to achieve MPP tracking. This would however require additional hardware and a communication link to obtain the information from the transmitter as well, and in this work a feedback loop is implemented based exclusively on measurements of the receiver.

This work utilises a MPP tracking algorithm. A quadrant check is first performed, testing four points that are 90° apart from each other, and the search is subsequently narrowed down to a specific quadrant. The algorithm will then perform a fine search to track the optimal phase, which corresponds to the maximum received power (negative power indicates power is received). Operation of the algorithm is summarised in FIG. 21.

This version of the algorithm takes an average of 5.6 seconds to run, as each point is measured several times and averaged. The execution time can however be problematic, especially when the power level is large and the system is operating sub-optimally: the transmitter or the receiver could be heating up and getting damaged.

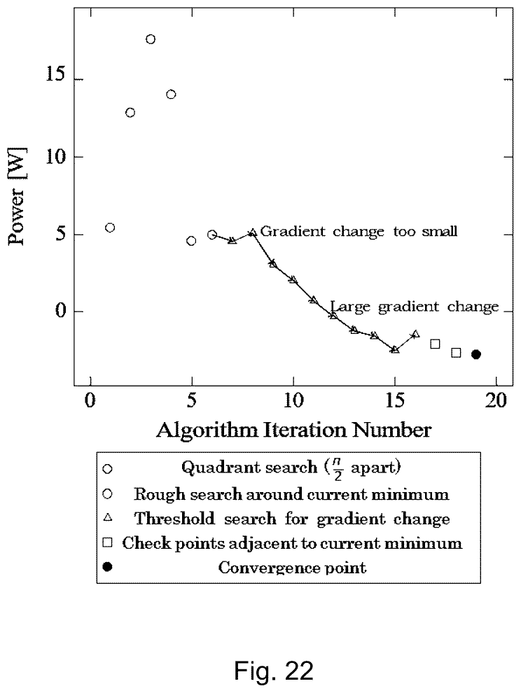

To address this issue the algorithm was modified to skip intermediate points in the narrow search, and testing the two neighbouring point of the last optimal point that has been found. A further modification is an interruption of the fine search when a positive gradient above a certain threshold is detected in the measurement. These modifications are shown in FIG. 22. These changes, together with a decreased amount of measurement per tested point, led to a decrease of the execution time to 1.6 seconds (20 steps with an average of 80 ms per step). The first step is a quadrant search, testing four different points which are selected to be 90° away from each other. Two points near the current optimal solution are then tested before initiating a rough search in 4° steps. This step aims to find an unambiguous change in gradient, corresponding to a local minimum. Two points near the candidate solution for local minimum are then tested to ensure convergence to the optimal phase.

With the first method an average phase error of 2° was obtained, while with the second method the average error was 5°. This can be attributed to the decreased amount of measurement time per point, together with the fact that the second method is skipping intermediate points in the fine search: when samples are not skipped, it is likely that neighboring samples will have somewhat similar values. This means that the effect of noise in a specific sample on the final convergence value is minimised by the presence of its neighbours acting as a form of extra averaging.

This issue was addressed by performing subsequent corrections after convergence at fixed time intervals of 5 seconds. In addition to bringing the error back down to 2°, these post-convergence corrections help ensure that the system is still operating under the MPP even under a change of conditions such as coupling or the introduction of foreign objects.

Another advantage of using a faster algorithm is that the effect of slow temperature changes in proximity of the oscillator circuit will have an almost negligible effect on convergence. If the algorithm was extremely slow, it is possible that the MPP tracking would be affected by a change of temperature of the environment, which could cause a change in ω₀, hence causing a drift in the phase.

This paper presents a solution which does not require a separate communication link, eliminates complicated signal processing tasks, and allows operation under extremely low coupling conditions. The auxiliary circuitry does not require any high-performance instrumentation, making it possible to be integrated in the system as a low-cost solution for active-active operation.

The closed loop system was tested in different coupling arrangements, achieving a maximum power transmission of 25.7 W for a coupling of 8.4%, with an end-to-end efficiency of 60.9%.

### VI. Conclusion

This work shows a technique to achieve frequency and phase synchronisation of an HF-IPT system where both sides are active, enabling the possibility of synchronous and bidirectional operation.

The basic principles of injection locking are discussed and it demonstrated how this can be applied to a bidirectional HF-IPT system operating at 13.56 MHz for couplings between 1.2% and 8.4%, together with experimental results showing the power exchanged at each coupling.

The possibility of closed loop operation has been presented together with experimental results for a closed loop design to account for temperature variations and a MPP tracking approach to fine-tune the optimal phase.

1. A wireless power transfer system comprising:
a transmitter unit, the transmitter unit comprising a first transceiver coupled to a first inductive coil and configured to drive the first inductive coil; and
a receiver unit, the receiver unit comprising a second transceiver coupled to a second inductive coil for inductive coupling with the first inductive coil;
wherein the receiver unit further comprises an injection-locked oscillator coupled to the second transceiver for defining an oscillation frequency of the second transceiver, the injection-locked oscillator configured to synchronize with a driving frequency of the transmitter unit.

2. The wireless power transfer system of claim 1,
wherein the transmitter unit further comprises an oscillator coupled to the first transceiver, the oscillator defining a stable oscillation frequency of the first transceiver.

3. The wireless power transfer system of claim 1,
wherein the injection-locked oscillator has a low Q-factor.

4. The wireless power transfer system of claim 1,
wherein the injection-locked oscillator is a non-linear oscillator.

5. The wireless power transfer system of claim 1,
wherein at least one of the first transceiver and the second transceiver is a class EF transceiver.

6. The wireless power transfer system of claim 1,
wherein at least one of the first inductive coil and the second inductive coil comprises an air-coil.

7. The wireless power transfer system of claim 1,
wherein the first transceiver and the second transceiver are of a same class.

8. The wireless power transfer system of claim 1,
wherein the receiver unit further comprises a delay line configured to maintain a phase offset of 90° relative to the transmitter unit.

9. The wireless power transfer system of claim 1,
wherein the second transceiver is tuned to achieve load independence from the first transceiver.

10. The wireless power transfer system of claim 1,
wherein the injection-locked oscillator is a voltage-controlled injection-locked oscillator having a voltage-tuneable natural oscillating frequency.

11. The wireless power transfer system of claim 1,
wherein the receiver unit further comprises a temperature sensor, and a control unit configured to determine a temperature at the receiver unit based on an output from the temperature sensor.

12. The wireless power transfer system of claim 11,
wherein the injection-locked oscillator is a voltage-controlled injection-locked oscillator having a voltage-tuneable natural oscillating frequency,
wherein the control unit is configured to:
determine, based on the output from the temperature sensor, a change in temperature at the receiver unit;
determine, based on a lookup table, a change in natural oscillating frequency of the injection-locked oscillator corresponding to the temperature change;
determine, based on the determined change in natural oscillating frequency, a change in voltage required to counteract the change; and
apply the change in voltage to the injection-locked oscillator.

13. The wireless power transfer system of claim 11, wherein the control unit is configured to:
cause a delay line to introduce phase perturbations onto an oscillation signal sent to the second transceiver from the injection-locked oscillator;
for each phase perturbation, determine, based on an output from the second transceiver, an induced power at the receiver unit;
determine a phase perturbation at which the induced power is largest; and
control the delay line to maintain the phase perturbation at which the induced power is largest.

14. A method of controlling a receiver unit for use in an inductive power transfer system, the receiver unit comprising a transceiver coupled to an inductive coil, a voltage-controlled injection-locked oscillator coupled to the transceiver for defining an oscillation frequency of a second transceiver, the method comprising:
determining a change in temperature at the receiver unit;
determining a change in natural oscillating frequency of the injection-locked oscillator corresponding to the temperature change;
determining a change in voltage required to counteract the change; and
applying the change in voltage to the injection-locked oscillator.

15. A method of controlling a receiver unit for use in an inductive power transfer system, the receiver unit comprising a transceiver coupled to an inductive coil, a voltage-controlled injection-locked oscillator coupled to the transceiver for defining an oscillation frequency of the transceiver, and a delay line, the method comprising:
causing the delay line to introduce phase perturbations onto an oscillation signal sent to the transceiver from the injection-locked oscillator;
for each phase perturbation, determining, based on an output from the transceiver, an induced power at the receiver unit;
determining a phase perturbation at which the induced power is largest; and
controlling the delay line to maintain the phase perturbation at which the induced power is largest.
